(19) United States
(12) Patent Application Publication
(10) Pub. No.: US 2009/0308928 A1
(43) Pub. Date: Dec. 17, 2009

(54) SYSTEM TO IMPROVE COMMUNICATION USING A LASER BAR CODE SCANNER AND ASSOCIATED METHODS

(76) Inventors: Janani Janakiraman, Austin, TX (US); David Bruce Kumhyr, Austin, TX (US)

Correspondence Address: LAW OFFICE OF IDO TUCHMAN (AUS), ECM #72212, PO Box 4668, New York, NY, 10163-4668, US

(21) Appl. No.: 12/136,853

(22) Filed: Jun. 11, 2008

(51) Int. Cl. G06K 7/10

(52) U.S. Cl. 235/462.32

(57) ABSTRACT

A system to improve communication may include a laser barcode scanner to generate a laser-light to read barcodes. The system may also include a controller to determine a state of operation of the laser barcode scanner. The system may further include a projection unit to provide the laser-light as human understandable information based upon the controller's determination.

### FIELD OF THE INVENTION

The invention relates to the field of computer systems, and, more particularly, to laser bar code scanners.

### BACKGROUND OF THE INVENTION

A barcode scanner is usually an electronic device for interpreting machine readable code. A barcode scanner can come in many different configurations and use various types of image sensors to identify the machine readable code. For instance, the image sensors may include photodiodes, charge-coupled devices, video cameras, and the like in communication with a light source. The light source may include an incandescent light, a laser beam, a light emitting diode, or the like.

U.S. Pat. No. 7,178,732 to Barron et al. discloses a barcode scanning system that may include a laser and a detector. The system may further include an image illumination device to illuminate a printed or embossed image.

U.S. Pat. No. 5,557,093 to Knowles et al. discloses a barcode scanner that may include a laser and a detector. The system also includes a group of mirrors in spaced relation along with a rotating mirror to create a scanning pattern using a laser beam generated by the laser.

### SUMMARY OF THE INVENTION

In view of the foregoing background, it is an object of the invention to provide a system to more efficiently use barcode scanners.

This and other objects, features, and advantages in accordance with the invention are provided by a system to improve communication that may include a laser barcode scanner to generate a laser-light to read barcodes. The system may also include a controller to determine a state of operation of the laser barcode scanner. The system may further include a projection unit to provide the laser-light as human understandable information based upon the controller's determination.

The laser-light as human understandable information may include at least one of error code information and advertisement information. The laser barcode scanner may comprise a point-of-sale device.

The system may also include a surface adjacent the laser barcode scanner to receive the laser-light as human understandable information. The laser barcode scanner's state of operation may include at least one of reading barcode data, providing error code data, and providing advertisement data.

The controller may send advertisement data to the projection unit based upon an advertisement unit in communications with the controller. The controller may also determine if barcode data should be processed, if error code data should be sent to the projection unit, and if advertisement data should be sent to the projection unit based upon the state of operation. The controller may send advertisement data to the projection unit based upon barcode data that is processed.

Another aspect of the invention is a method to improve communication that may include generating a laser-light to read barcodes via a laser barcode scanner. The method may also include determining a state of operation of the laser barcode scanner, and providing the laser-light as human understandable information based upon the determination.

The method may further include transmitting the laser-light as human understandable information to a surface adjacent the laser barcode scanner. The method may additionally include determining if barcode data should be processed, if error code data should be sent, and if advertisement data should be sent based upon the state of operation. The method may also include sending advertisement data based upon barcode data that is processed.

### BRIEF DESCRIPTION OF THE DRAWINGS

FIG. 1 is a schematic block diagram of a system to improve communication using a laser barcode scanner in accordance with the invention.

FIG. 2 is a flowchart illustrating method aspects according to the invention.

FIG. 3 is a flowchart illustrating method aspects according to the method of FIG. 2.

FIG. 4 is a flowchart illustrating method aspects according to the method of FIG. 2.

FIG. 5 is a flowchart illustrating method aspects according to the method of FIG. 4.

FIG. 6 is a prophetic example system in accordance with the invention of FIG. 1.

FIG. 7 depicts one embodiment of an article of manufacture incorporating one or more aspects of the invention.

### DETAILED DESCRIPTION OF THE PREFERRED EMBODIMENTS

The invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternative embodiments.

As will be appreciated by one skilled in the art, the invention may be embodied as a method, system, or computer program product. Furthermore, the invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, or a magnetic storage device.

Computer program code for carrying out operations of the invention may be written in an object oriented programming language such as Java, Smalltalk, C++ or the like. However, the computer program code for carrying out operations of the invention may also be written in conventional procedural programming languages, such as the “C” programming language or similar programming languages.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

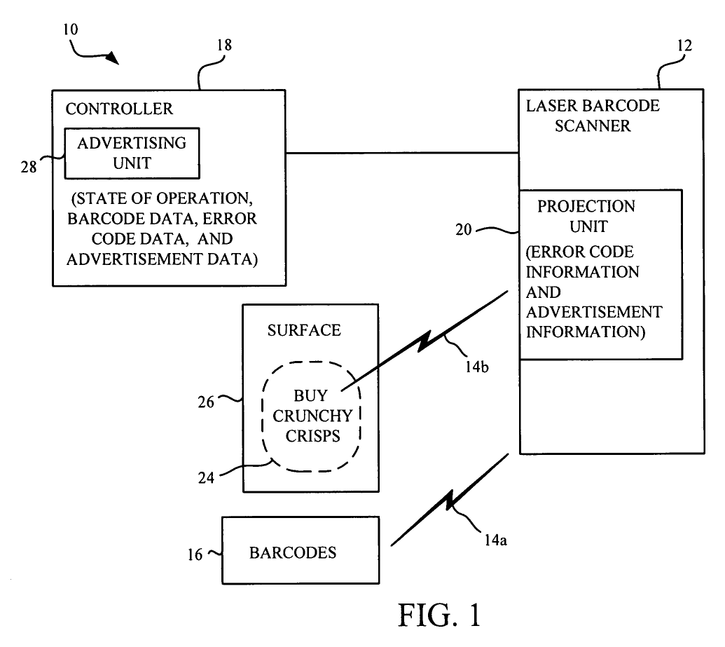

Referring to FIG. 1, a system 10 to improve communication using a barcode scanner is initially described. The system 10 includes a laser barcode scanner 12 to generate a laser-light 14a to read barcodes 16, for example. The laser barcode scanner 12 may be a fixed position scanner, a stationary scanner, a handheld scanner, a pen scanner, an automatic reader, or the like. In one embodiment, the laser barcode scanner 12 comprises a point-of-sale device as will be appreciated by those of skill in the art.

The system 10 also includes a controller 18 to determine a state of operation of the laser barcode scanner 12, for instance. The laser barcode scanner 12's states of operation include reading barcode data, providing error code data, and/or providing advertisement data, for instance.

In one embodiment, the controller 18 determines if barcode data should be processed, if error code data should be sent to the projection unit 20, and if advertisement data should be sent to the projection unit based upon the state of operation. In other words, the controller 18 determines the laser barcode scanner 12's states of operation based on the above listed operations. The controller 18 comprises hardware and/or software for data processing and system 10 control.

The system 10 further includes a projection unit 20 to provide laser-light 14b as human understandable information 24 based upon the controller's determination, for example. In one embodiment, the laser-light 14b as human understandable information 24 includes error code information and/or advertisement information.

Stated another way, the projection unit 20 manipulates the laser-light 14b into a format that a person would readily understand such as a message in alphanumeric characters, pictures, or the like under the management of controller 18, which considered the state of operation of the laser barcode scanner 12. For instance, the laser-light 14b as human understandable information 24 may produce advertisement information such as, “Buy crunchy crisps”. In another embodiment, the laser-light 14b as human understandable information 24 may produce error code information such as, “Please rescan item” (not shown) so that the user of the laser barcode scanner 12 would understand that the prior scan attempt was unsuccessful.

The system 10 also includes a surface 26 adjacent the laser barcode scanner 12 to receive the laser-light 14b as human understandable information 24, for example. In one embodiment, the controller 18 sends advertisement data to the projection unit 20 based upon an advertisement unit 28 in communications with the controller. In other words, the advertisement unit 28 works with the controller 18 to determine when and what advertisement data should be sent to the projection unit 20.

For example, the controller 18 sends advertisement data to the projection unit 20 based upon barcode data that is processed. Stated another way, the controller 18 determines what advertisement data is sent to the projection unit 20 using an algorithm that considers what item the barcode actually represents.

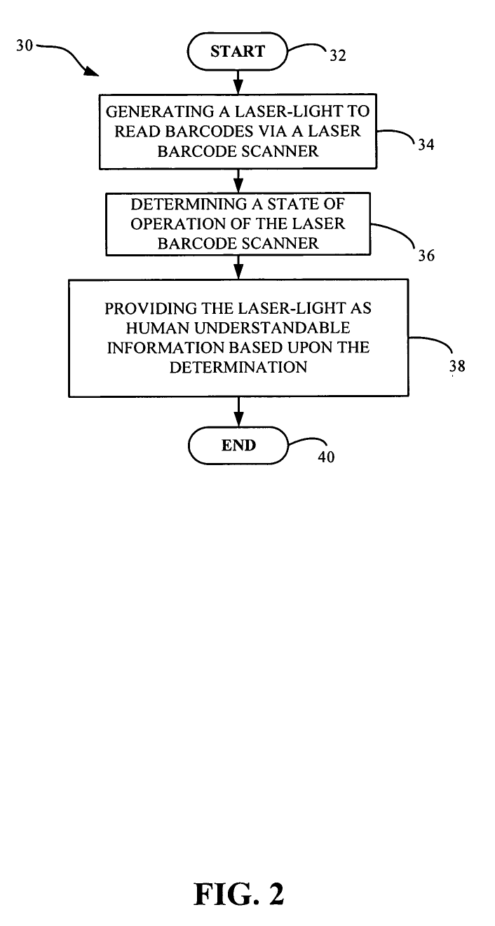

Another aspect of the invention is a method to improve communication using a laser barcode scanner, which is now described with reference to flowchart 30 of FIG. 2. The method begins at Block 32 and may include generating a laser-light to read barcodes via a laser barcode scanner at Block 34. The method may also include determining a state of operation of the laser barcode scanner at Block 36. The method may further include providing the laser-light as human understandable information based upon the determination at Block 38. The method ends at Block 40.

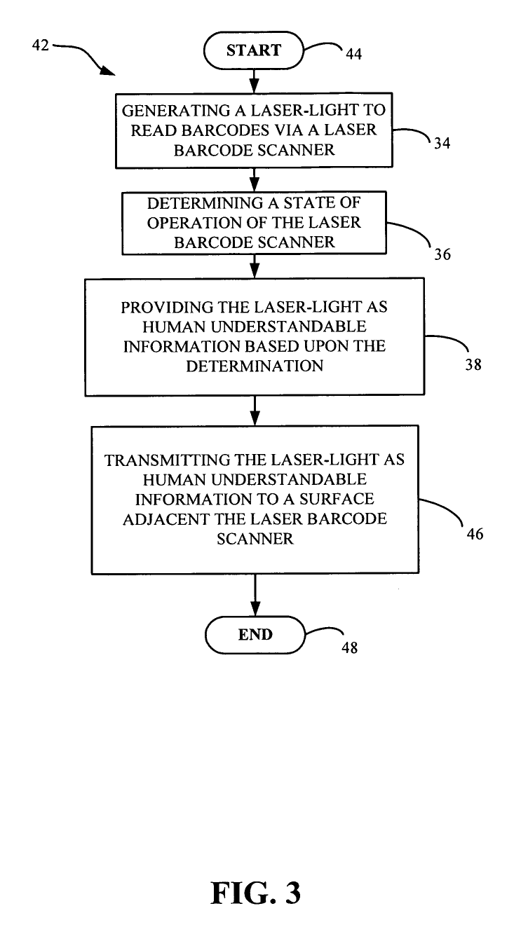

In another method embodiment, which is now described with reference to flowchart 42 of FIG. 3, the method begins at Block 44. The method may include the steps of FIG. 2 at Blocks 34, 36, and 38. The method may further include transmitting the laser-light as human understandable information to a surface adjacent the laser barcode scanner at Block 46. The method ends at Block 48.

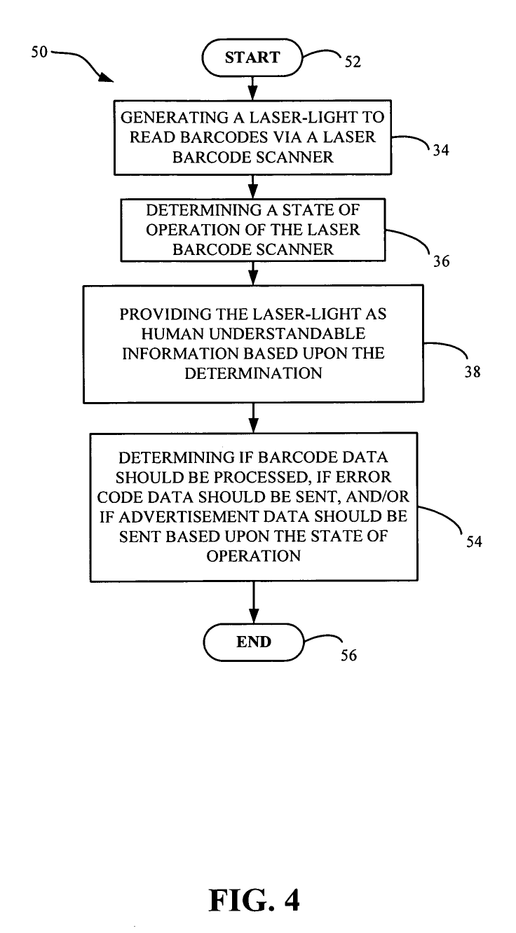

In another method embodiment, which is now described with reference to flowchart 50 of FIG. 4, the method begins at Block 52. The method may include the steps of FIG. 2 at Blocks 34, 36, and 38. The method may also include determining if barcode data should be processed, if error code data should be sent, and/or if advertisement data should be sent based upon the state of operation at Block 54. The method ends at Block 56.

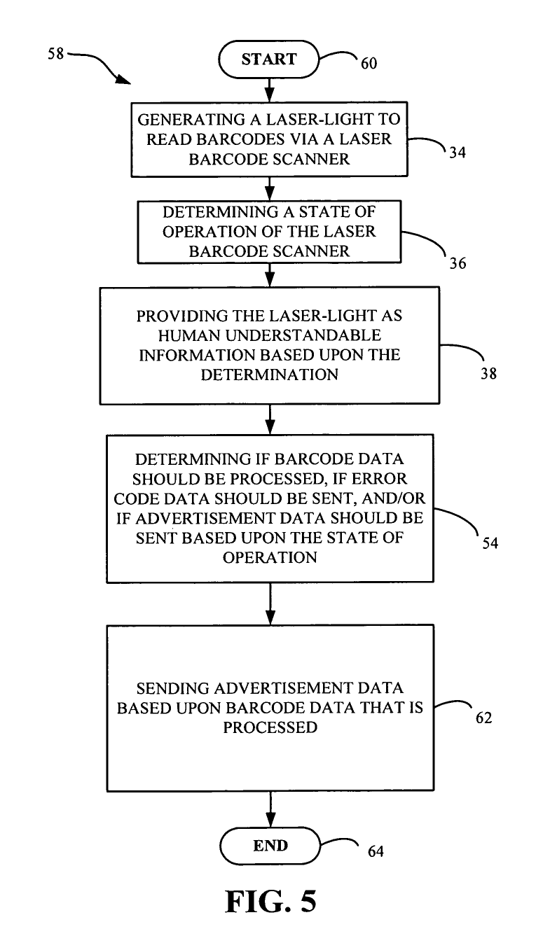

In another method embodiment, which is now described with reference to flowchart 58 of FIG. 5, the method begins at Block 60. The method may include the steps of FIGS. 2 and 4 at Blocks 34, 36, 38, and 54, respectively. The method may further include sending advertisement data based upon barcode data that is processed at Block 62. The method ends at Block 64.

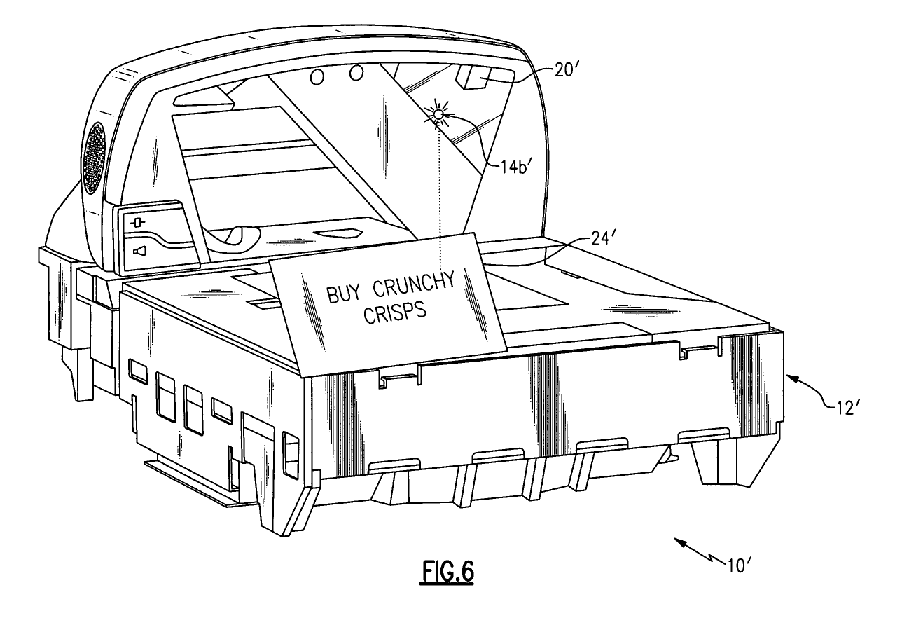

A prophetic example of how the system 10 may work is now described with additional reference to FIG. 6. In this embodiment, the system 10′ includes a laser barcode scanner 12′ which is a table mounted stationary scanner as is commonly found at a retailer, a supermarket, or the like. In this illustration, the laser barcode scanner 12's state of operation is providing advertisement data because no item is being scanned at this point in time. As a result, the projection unit 20′ manipulates laser-light 14b′ into a format that a person would readily understand such as the message “Buy crunchy crisps” 24′.

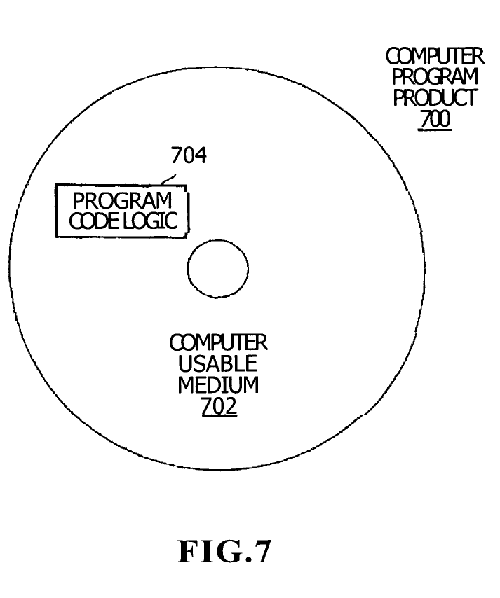

Another aspect of the invention is directed to embodiments that can be embodied in the form of computer-implemented processes and apparatuses for practicing those processes, which is now described with reference to FIG. 7. For example, the system 10 is embodied in computer program code executed by one or more network elements.

Embodiments include a computer program product 700 as depicted in FIG. 7 on a computer usable medium 702 with computer program code logic 704 containing instructions embodied in tangible media as an article of manufacture. Exemplary articles of manufacture for computer usable medium 702 may include floppy diskettes, CD-ROMs, hard drives, universal serial bus (USB) flash drives, or any other computer-readable storage medium, wherein, when the computer program code logic 704 is loaded into and executed by a computer, the computer becomes an apparatus for practicing the invention.

Embodiments include computer program code logic 704, for example, whether stored in a storage medium, loaded into and/or executed by a computer, or transmitted over some transmission medium, such as over electrical wiring or cabling, through fiber optics, or via electromagnetic radiation, wherein, when the computer program code logic 704 is loaded into and executed by a computer, the computer becomes an apparatus for practicing the invention. When implemented on a general-purpose microprocessor, the computer program code logic 704 segments configure the microprocessor to create specific logic circuits.

Additionally, at least one program storage device readable by a machine, tangibly embodying at least one program of instructions executable by the machine to perform the capabilities of the system 10 can be provided. The article of manufacture can be included as a part of a computer system or sold separately.

The capabilities of the system 10 can be implemented in software, firmware, hardware or some combination thereof.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention. Furthermore, the use of the terms a, an, etc. do not denote a limitation of quantity, but rather denote the presence of at least one of the referenced item.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

That which is claimed is:

1. A system to improve communication, the system comprising:
a laser barcode scanner to generate a laser-light to read barcodes;
a controller to determine a state of operation of said laser barcode scanner; and
a projection unit to provide the laser-light as human understandable information based upon said controller's determination.

2. The system of claim 1 wherein the laser-light as human readable information includes at least one of error code information and advertisement information.

3. The system of claim 1 wherein said laser barcode scanner comprises a point-of-sale device.

4. The system of claim 1 further comprising a surface adjacent said laser barcode scanner to receive the laser-light as human understandable information.

5. The system of claim 1 wherein said laser barcode scanner's state of operation includes at least one of reading barcode data, providing error code data, and providing advertisement data.

6. The system of claim 5 wherein said controller sends advertisement data to said projection unit based upon an advertisement unit in communications with said controller.

7. The system of claim 5 wherein said controller further determines if barcode data should be processed, if error code data should be sent to said projection unit, and if advertisement data should be sent to said projection unit based upon the state of operation.

8. The system of claim 7 wherein said controller sends advertisement data to said projection unit based upon barcode data that is processed.

9. A method to improve communication, the method comprising:
generating a laser-light to read barcodes via a laser barcode scanner;
determining a state of operation of the laser barcode scanner; and
providing the laser-light as human understandable information based upon the determination.

10. The method of claim 9 wherein the laser-light as human readable information includes at least one of error code information and advertisement information.

11. The method of claim 9 further comprising transmitting the laser-light as human understandable information to a surface adjacent the laser barcode scanner.

12. The method of claim 9 wherein the laser barcode scanner's state of operation includes at least one of reading barcode data, providing error code data, and providing advertisement data.

13. The method of claim 12 further comprising determining if barcode data should be processed, if error code data should be sent, and if advertisement data should be sent based upon the state of operation.

14. The method of claim 13 further comprising sending advertisement data based upon barcode data that is processed.

15. A computer program product embodied in a tangible media comprising:
computer readable program codes coupled to the tangible media to improve communication, the computer readable program codes configured to cause the program to:
generate a laser-light to read barcodes via a laser barcode scanner;
determine a state of operation of the laser barcode scanner; and
provide the laser-light as human understandable information based upon the determination.

16. The computer program product of claim 15 further comprising program code configured to: transmit the laser-light as human understandable information to a surface adjacent the laser barcode scanner.

17. The computer program product of claim 15 further comprising program code configured to: determine if barcode data should be processed, if error code data should be sent, and if advertisement data should be sent based upon the state of operation.

18. The computer program product of claim 17 further comprising program code configured to: send advertisement data based upon barcode data that is processed.
